(19) United States
(12) Patent Application Publication
(10) Pub. No.: US 2008/0082458 A1
(43) Pub. Date: Apr. 3, 2008

(54) Client Savings Modeling Tool

(75) Inventors: Andrea P. Airoldi, Merate (IT); Thomas P. Balcome, Raleigh, NC (US); Carol D. Broadwell, Hopewell Juction, NY (US); Graeme M. Dougal, Houston (GB); Wendy Lamont Flagstad, New York, NY (US); Janet Louise Skordby, Stockholm (SE); Thomas M. Ward, Highland, NY (US); Glenn G. Webb, Kyle, TX (US)

Correspondence Address: John E. Campbell;IBM Intellectual Property, 2455 South Road - P386, Poughkeepsie, NY, 12601, US

(73) Assignee: INTERNATIONAL BUSINESS MACHINES CORPORATION, Armonk, NY (US)

(21) Appl. No.: 11/536,876

(22) Filed: Sep. 29, 2006

(51) Int. Cl. G06Q 40/00

(52) U.S. Cl. 705/36 R

(57) ABSTRACT

A method, computer system, and program product for estimating savings realized in an enterprise. Data is input into a computer reflecting the dividing of the enterprise into sections Also input the computer is data reflecting the dividing of each section into one or more functions and recording the money spent for each function over a specified period of time. Also input into the computer is data recording the maturity of each function based on standardized criteria and percent improvement data for evaluating savings to be realized as the function improves from one maturity level to a higher maturity level. The computer estimates savings to be realized for each function as the function matures from one maturity level to a higher maturity level and consolidates savings to be realized for all functions in a section and all sections in tile enterprise. The computer publishes the savings in a report for evaluation

### FIELD OF THE INVENTION

This invention relates to modeling client savings, and particularly to tools, methods and a program product for modeling consistent maturity assessment and savings calculations.

### BACKGROUND OF THE INVENTION

U.S. Pat. No. 5,884,283 issued Mar. 16, 1999 to Manos for SYSTEM, METHOD AND PROGRAM PRODUCT OF MANAGING AND CONTROLLING THE DISPOSITION OF FINANCIAL RESOURCES (incorporated herein by reference) discloses a method, computer program product and system providing management and control of the disposition of personal financial resources, taking into account the effects of inflation and deflation. The compounding effect of inflation or deflation is applied to actual amounts for gross income, income taxes, after-tax income, living costs and savings to project targets for these amounts through the projected period by applying to the actual amounts, the estimated rate of inflation or deflation and rates that are related to these rates.

WIPO International Publication Number WO 01/25876 A2 published Apr. 12, 2001 by Anderson Consulting L.L.P. for METHOD AND ESTIMATOR FOR PROVIDING CAPACITY MODELING AND PLANNING (incorporated herein by reference) discloses a method for providing or building a capacity modeling and planning function in an information technology organization includes conducting the tasks involved in building the capacity modeling and planning function. The tasks include the planning, analyzing, designing, building, testing, and deploying the capacity modeling and planning function. Each task includes process, organization, and technology infrastructure elements. Another aspect of the invention is a method for providing an estimate for building a capacity modeling and planning function in a in an information technology organization. This aspect of the present invention allows an IT consultant to give on site estimation to a client within minutes. The estimator produces a detailed break down of cost and time to complete a project by displaying the costs and time corresponding to each stage of a project along with each task. Another aspect for the present invention is a computer system for allocating time and computing cost for building a capacity modeling and planning function in an information technology organization.

WIPO International Publication Number WO 00/72212 A2 published Nov. 30, 2000 by Lockheed Martin Corp. for MULTI-DISCIPLINARY INFORMATION ENGINE FOR TOTAL OWNERSHIP COST ESTIMATION OF COMPLEX SYSTEMS (incorporated herein by reference) discloses a system and method for determining a total ownership cost associated with a complex system (or a component thereof includes a multi-disciplinary environment including a least one tool, a product data manager, and total ownership costs assessment tools. The tools in the multi-disciplinary environment are used to gather information regarding the complex system. The product data manager receives the information from the tools and organizes the information as an information model representing the complex system. The total ownership cost assessment tool extracts various system and related scheduling aspects form the information model and determines the total ownership cost associated with the complex system. (or the component thereof. The invention is directed toward a multi-disciplinary information engine for estimating a total ownership cost of a complex system. While the invention focuses on and is described in terms of total ownership costs, it should be understood that other parameters could be estimated including product performance assessment, project management, operations concept analysis, sparing, or any other parameter with complex inter-relationships that exist within a multi-disciplinary environment.

### SUMMARY OF THE INVENTION

The present invention provides data necessary for calculating client savings resulting from indirect procurement sourcing during the tenure of a business transformation offering procure to pay engagement. The invention uses many business specific equations, including client procurement maturity level assessment, standard savings ranges, strategic sourcing compliance levels, and other information, to calculate the projected savings based on a historical client spend profile.

The present invention provides a method, tool and program product for refining the corporate procurement outsourcing process. The business process and the tool designed to support the process provide for estimating savings realized by improving maturity measurements of elements of the procurement process.

The present invention provides a method, computer system, and program product for estimating savings realized in an enterprise. Data is input into a computer reflecting the dividing of the enterprise into sections. Also input into the computer is data reflecting the dividing of each section into one or more functions and recording the money spent for each function over a specified period of time. Also input into the computer is data recording the maturity of each function based on standardized criteria and percent improvement data for evaluating savings to be realized as the function improves from one maturity level to a higher maturity level. The computer estimates savings to be realized for each function as the function matures from one maturity level to a higher maturity level and consolidates savings to be realized for all functions in a section and all sections in the enterprise. The computer publishes the savings in a report for evaluation

The present invention also provides for an electronic questionnaire which is electronically linked to the input tab of a spreadsheet for estimating savings and consolidating savings for a client savings model.

The present invention also provides for the continuous validation and updating of a client savings model.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic drawing of a computer system usable with the present invention;

FIGS. 2A and 2B, assembled as shown in the map of FIG. 2, forms a flow diagram of the process of the present invention;

FIG. 3 is a flow diagram of the savings estimation model components of the process illustrated in FIGS. 2A and 2B;

FIG. 4 is a presentation of the general requirements of the flow process of FIGS. 2A and 2B;

FIG. 5 is a illustration of the electronic link between an electronic questionnaire and an electronic spreadsheet program to be run in the computer system of FIG. 1;

FIG. 6 is a presentation of the category specific requirements of the collection of detailed information of the process of FIG. 3;

FIG. 7 is a presentation of the maturity assessment frame of the process of FIG. 3;

FIG. 8 illustrates the score values used in the maturity measurements of the process of FIG. 3;

FIG. 9 is an illustration of one embodiment of the section definitions whose maturity is measured;

FIG. 10 is as illustration of one embodiment of the functions of organizational planning and deployment section of FIG. 9;

FIG. 11 is an illustration of one embodiment of the functions of the spend and savings management section of FIG. 9;

FIG. 12 is an illustration of one embodiment of the functions of the procurement and sourcing strategy section of FIG. 9;

FIG. 13 is an illustration of one embodiment of the functions of the supply management leadership section of FIG. 9;

FIG. 14 is an illustration of one embodiment of the functions of the contract and supplier management section of FIG. 9;

FIG. 15 is an illustration of one embodiment of the functions of the procurement execution section of FIG. 9;

FIG. 16 is an illustration of the sourcing maturity indicators used to evaluate the functions of FIGS. 10-15;

FIGS. 17-21 gives one embodiment of the specific criteria used to assign the maturity stage to the five functions of the organizational planning and deployment section shown in FIG. 10;

FIG. 22 is an illustration of the determination of the weighted score of the sections of FIG. 9;

FIG. 23 is a presentation illustrating the standard savings ranges by category of FIG. 3.

FIG. 24 is a presentation illustrating the savings calculation model of FIG. 3;

FIGS. 25A, 25B, and 25C, assembled as shown in the map of FIG. 25, is a listing of input tab of one embodiment of a spreadsheet of the process of FIG. 3;

FIGS. 26A and 26B, assembled as shown in the map of FIG. 26, illustrates an example of a scenario maturity profile used in the process of FIG. 3;

FIG. 27 and 28 illustrates one embodiment of the output tab of the spreadsheet of the process of FIG. 3;

FIGS. 29A and 29B assembled as shown in the map of FIG. 29 is an illustration of a savings summary by contract year for a scenario for contract year of one embodiment of the spreadsheet of the process of FIG. 3;

FIGS. 30A and 30B assembled as shown in the map of FIG. 30 is an illustration of a savings summary by wave (over total contract duration) of one embodiment of the spreadsheet of the process of FIG. 3; and

FIGS. 31A and 31B assembled as shown in the map of FIG. 31 is an illustration of a savings summary by wave vs. baseline spend of one embodiment of the spreadsheet of the process of FIG. 3.

The detailed description explains the preferred embodiments of the invention, together with advantages and features, by way of example with reference to the drawings.

### DETAILED DESCRIPTION OF THE INVENTION

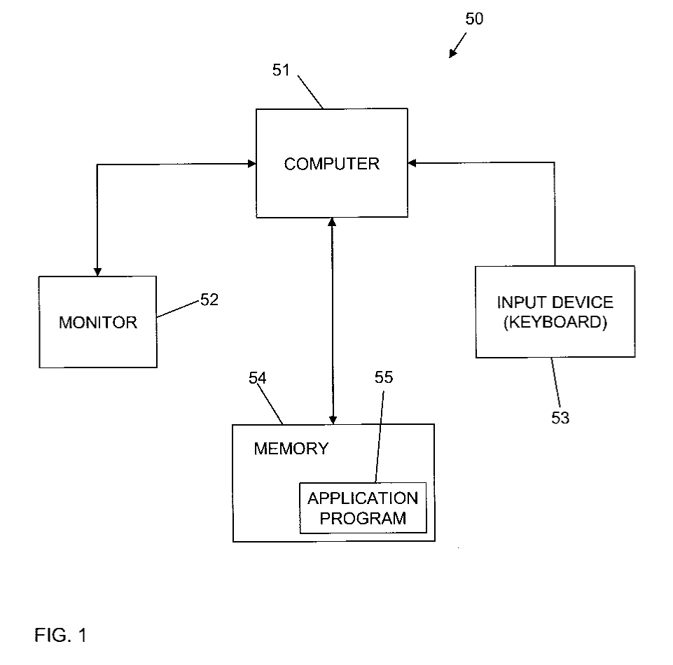

FIG. 1 is a schematic drawing of a computer system 50 having a computer 51, a monitor 52, and an input device 53 such as a keyboard or a diskette or compact disk (CD) reader. The computer system also includes a memory 54 in which is stored one or more application programs 55 for execution by the computer 51. As will be explained later, the application program 55 may be an electronic questionnaire or a spreadsheet program such as Excel available from Microsoft Corp. The computer system 50 may also include peripheral devices such as printers, disk drive devices, etc. The computer 51 may be a single computer or a network of printers, disk drive devices, etc. The computer 51 may be a single computer or a network of computers, as is well known in the art, and will not be explained further.

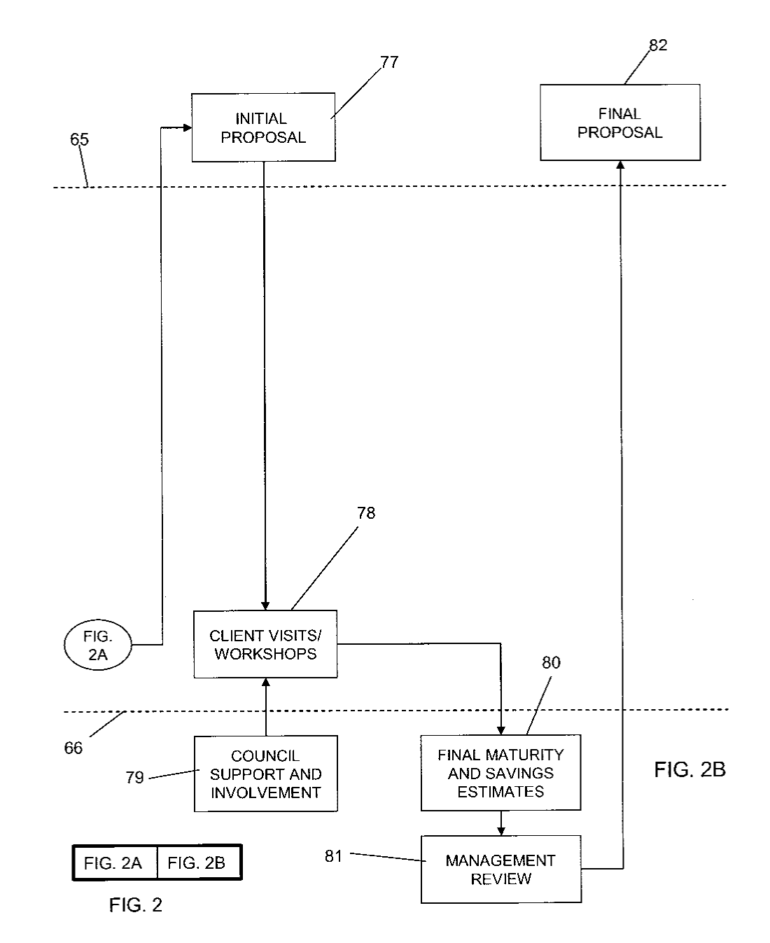

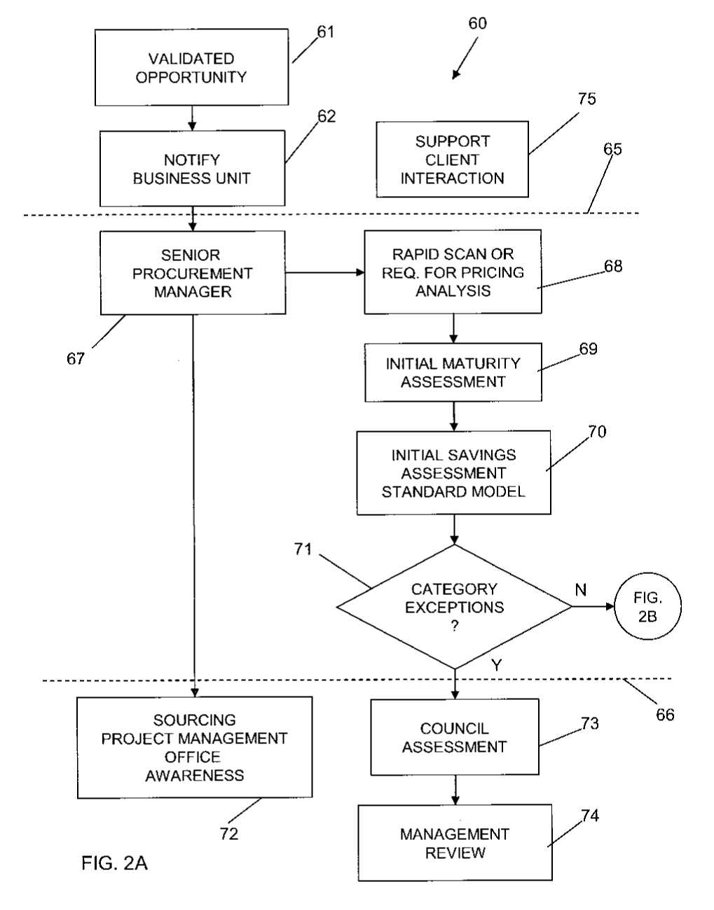

FIGS. 2A and 2B, assembled as shown in the map of FIG. 2, form a flow diagram of the process 60 of the present invention. At 61, a validated opportunity is recognized, and the proper business unit is notified at 62. In FIGS. 2A and 2B, everything above the line 65 is preferable performed by the Business Transformation Office (BTO) or the Business Consulting Service (BCS). Below the line 65 and above the line 66 is preferable performed by Procurement Services, and everything below the line 66 is preferably performed by Sourcing Councils. At 67, the senior procurement manager is engaged by the business unit, who makes a rapid scan or requests a pricing analysis at 68. At 69, an initial maturity assessment is made to determine the maturity, to be explained, of each function involved in the procurement process. At 70, an initial savings assessment standard model is established, and category exceptions are checked at 71. At 72, the senior procurement manager also makes the sourcing project management office aware of the analysis being conducted. If there are category exceptions identified at 71, they are assessed by the appropriate council at 73 and reviewed by management at 74. All during this process, the BTO/BCS supports client interaction at 75. If there are no category exceptions, the BTO/BCS presents an initial proposal at 77. Procurements services then conducts client visits and workshops at 78 to further the aims set out in the initial proposal. These visits and workshops include council support and involvement at 79. At 80, the final maturity stages are determined and the savings estimates are established. Management review is conducted at 81, and the final proposal is made at 82.

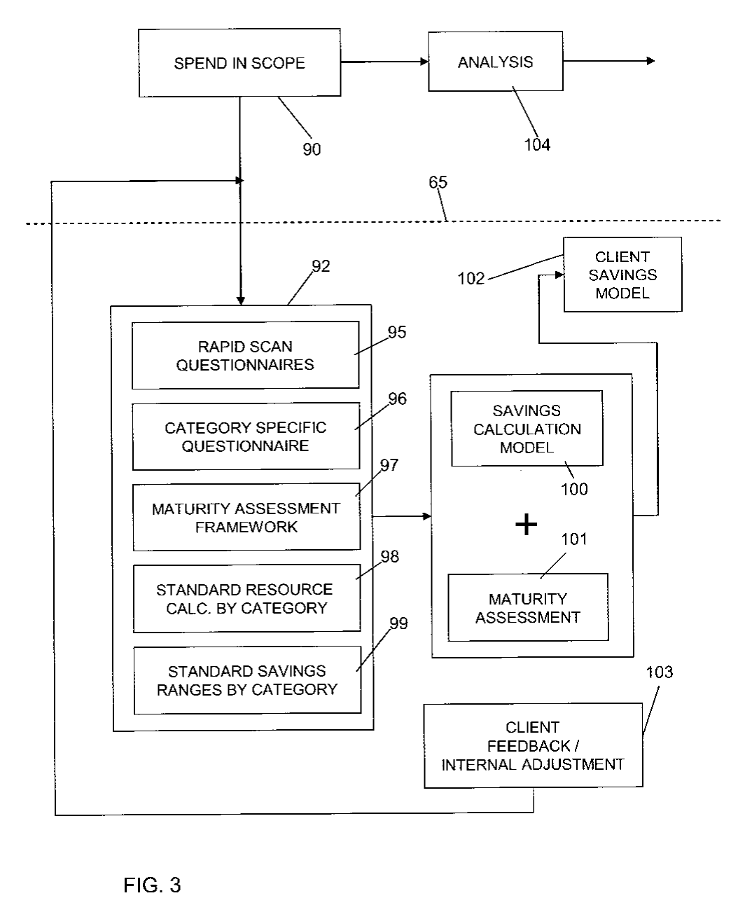

FIG. 3 is a flow diagram of the savings estimation model components. At 90, the initial step identifies the procurement category in scope for the client. Typically, this comes in the form of a historical annual spend amount which the client expended to procure each category in the previous year. For example: $325M for Technical Services spending and $42M for Travel related expenditures. Preferably, this spend is provided at a country (i.e. France) or geography level (Asia pacific) in a subcategory (i.e. Hotel spending as a subset of Travel). When the spend data has been obtained and validated with the client, this spend data is mapped into defined Indirect Procurement Categories. This annual spend detail is used as an input to the savings model 92.

The next step in the model 92 is to provide the client with rapid scan questionnaires at 95 and category specific questionnaires at 96. These questionnaires provide insight into the current business process applied for these Indirect Procurement Categories. These provide a vehicle for Client subject matter experts to connect with Procurement Services subject matter experts for each category. This also allows these subject matter experts to validate spending levels determine at 90, maturity levels (to be discussed) and potential savings opportunities. Rapid Scan questionnaires are completed at 95 and more detailed Category Specific questionnaires are completed at 96 for each Indirect Sourcing sub-category supported in the savings model 92.

At the maturity assessment framework step 97, a maturity assessment is established to evaluate the maturity level of the client's indirect procurement processes. A maturity assessment scale of 1-5 (to be explained) is used. Areas or sections for maturity evaluation are: 1.0 Organization Planning and Deployment; 2.0 Spend and Savings Management; 3.0 Procurement and Sourcing Strategy; 4.0 Supply Management Leadership; 5.0 Contract and Supplier Management; and 6.0 Procurement Execution. These sections will be explained.

At 98, the standard resource calculation by category step is performed. The savings model 92 defines addressable spend by category (commodity). The category is defined as groupings of sourcing activities with similar characteristics. A Full Time Equivalent (FTE) estimator applies addressable spend to pre-defined metrics. The FTE estimator calculates resources required for Client delivery.

At 99, the standard savings ranges by category step are performed. The standard savings (also known as “seeds”) represent a savings percentage by category for an average maturity level. The percentages are derived by gathering sourcing savings from a number of sources, including: standardized internal savings, BCS Savings taxonomy, existing BTO account target/actual savings, previously identified standard savings. The standard savings are revised every six months as at 98 to improve their accuracy and reliability. The percentages so derived are not provided in a separate file, but included in the Savings Calculation Model (to be discussed): the user should not act on these standard ranges.

After these steps are performed, the results are provided to the savings calculation model 100, which, with the maturity assessment 101, is used to complete a client savings model 102. After completion of data gathering from the customer in the savings model 92 and finalization of the Maturity Assessment 101, all available data must be entered into the “Input” tab of the Savings Calculation Model.

The fields of one embodiment are:
Spend: this comes from the spend in scope step 90 (spend analysis).
% addressable spend: the % of addressable spend is either indicated by the client, but most often must be evaluated by the engagement team on the basis of the Rapid Scan questionnaires of 95.
Tactical spend % by year: the evaluation ofthe split between spend that will be strategically and tactically sourced is based on spend analysis or in absence of data from the clients on standard profiles.
Wave number: The assignment of a spend category to a wave is done on the basis of several factors and in particular account savings yield/ease of implementation of each category of spend.
Wave start: The beginning of each wave of categories is defined in accordance to the overall solution and resource plan and has not a fixed schedule, although normally each wave starts 12 months later then the previous one.
Wave delay: This input is required to calculate the delay of savings on the start of the sourcing activity, due the time required to bring to conclusion one sourcing cycle. It is a default value of 6 months that can be amended based on specific information on the client's sourcing environment.
Initial Maturity: The initial Maturity is input on the basis of the results of the Maturity assessment frame 97, performed either at client level or a category level.
Compliance %: The compliance % is a value that needs to be estimated for the entire duration of the contract on the basis of Rapid Scan and additional information from the client. Compliance represent an estimate of the client ability to implement standardized sourcing recommendations and thus to actually achieve the estimated savings.

In one embodiment, once this data are entered, the user estimates a maximum of three scenarios which differs in the maturity profile over the contractual duration. In fact the model will return different savings estimates depending not only on the initial maturity but also on the basis of the above inputs, the model will calculate savings projections over a period of five years.

The model provides output for each of the three scenarios, and calculates yearly savings according to the input wave structure; different views of the savings (by category, council etc.) are calculated, inclusive of monetary and % savings amounts. Calculations are based on algorithms derived from council savings percentages (cost take out and General Procurement Competitive Advantage), and contract time periods.

In order to ensure increased accuracy of the model, a “continuous” validation and update process may be performed as shown at 103 and 104. At desired intervals the standard savings and the model outputs may be validated on the basis of actual performance of standardized procurement internally and for BTO clients.

The core algorithm is also validated against the data above. Major updates can include enhancement to the output formats and additional functionality required by the users.

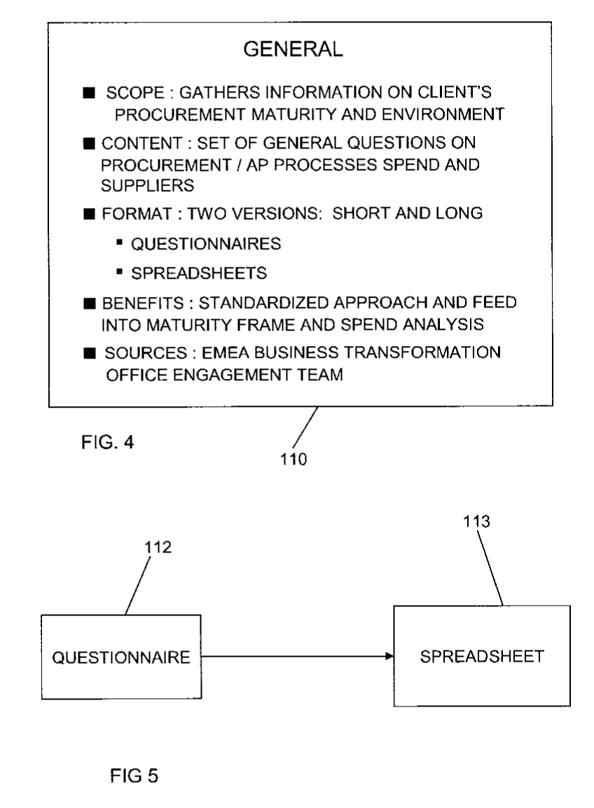

FIG. 4 is a presentation 110 of the general requirements of the flow process. As noted, two formats are presented. Questionnaires are used to provide input data, and a spreadsheet format is used to process the data and provide output. In one embodiment shown in FIG. 5, the questionnaire is in electronic form 112 which is linked to a spreadsheet 113 such that entering data into the questionnaire is automatically entered into the proper input tab in the spreadsheet 113.

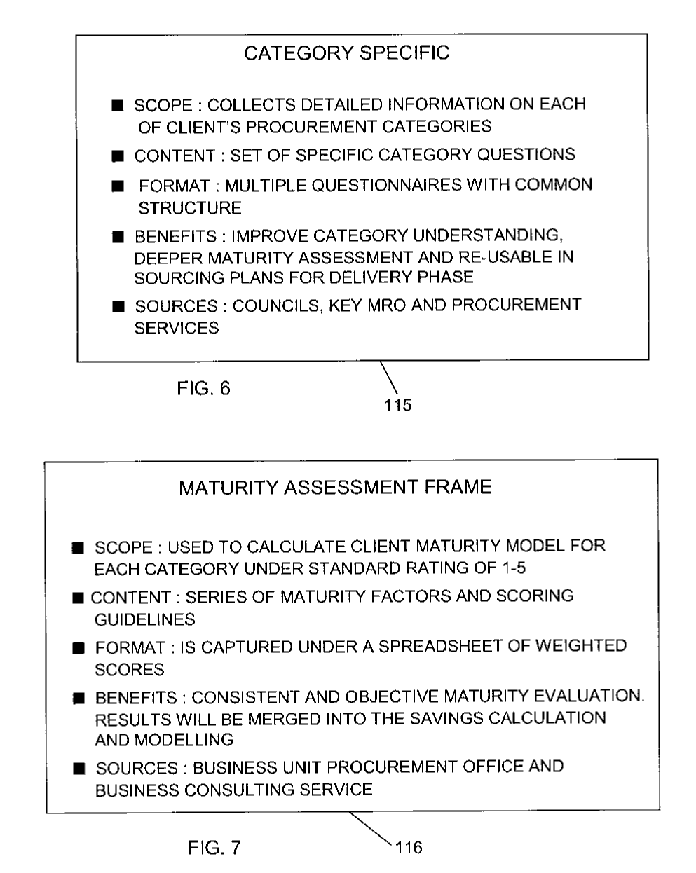

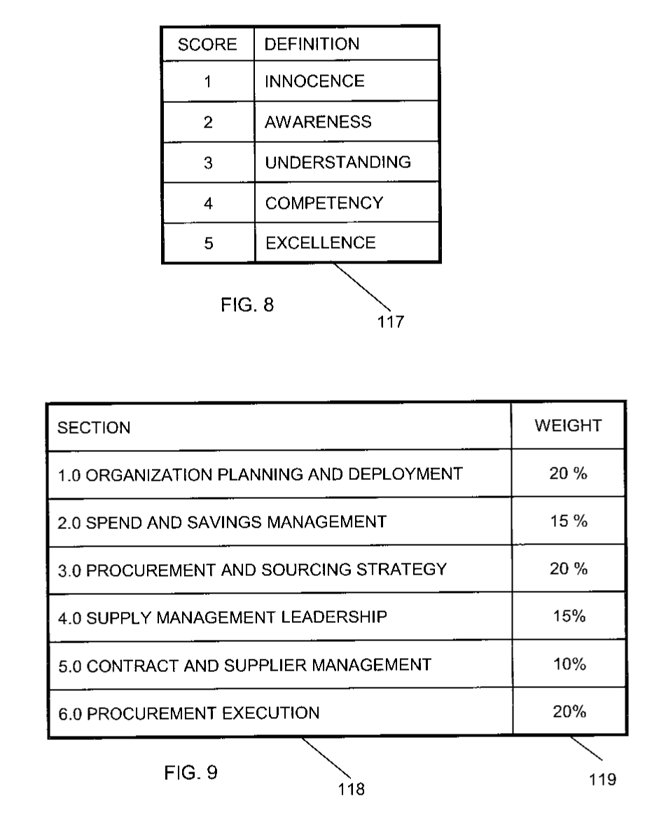

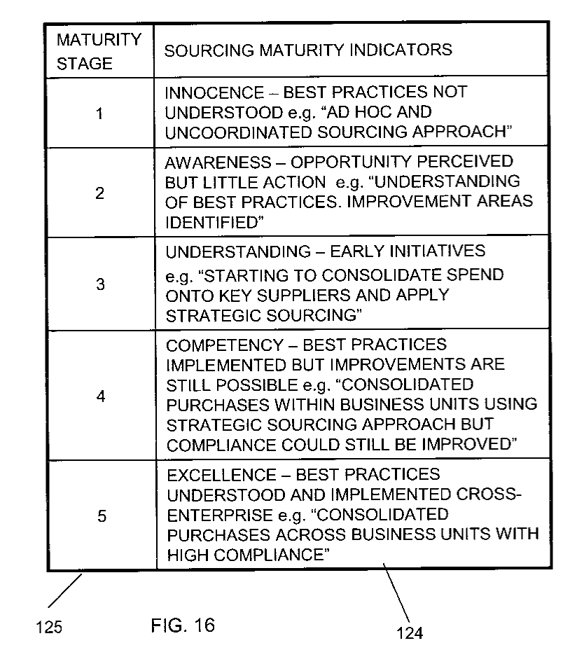

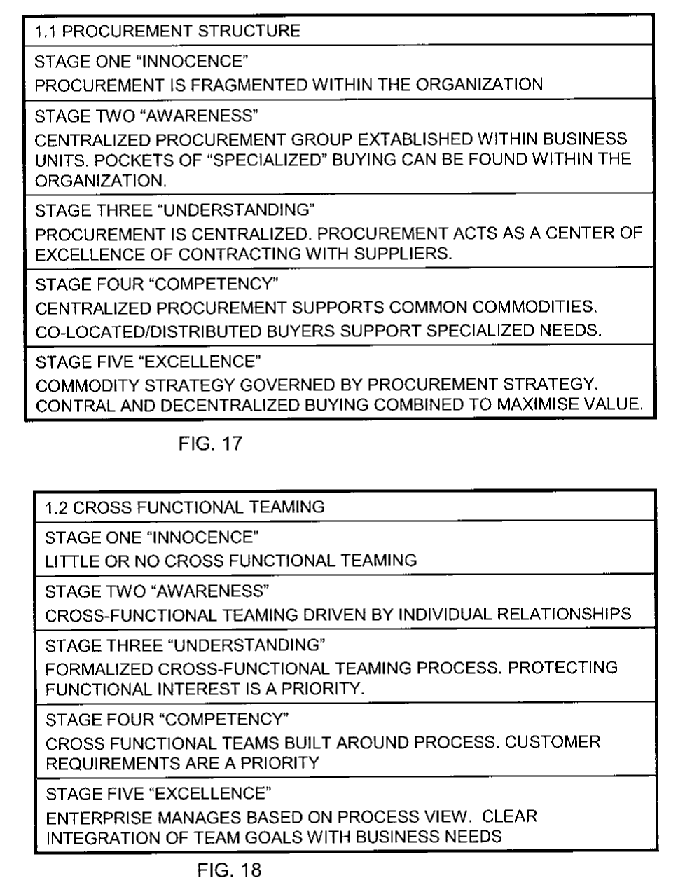

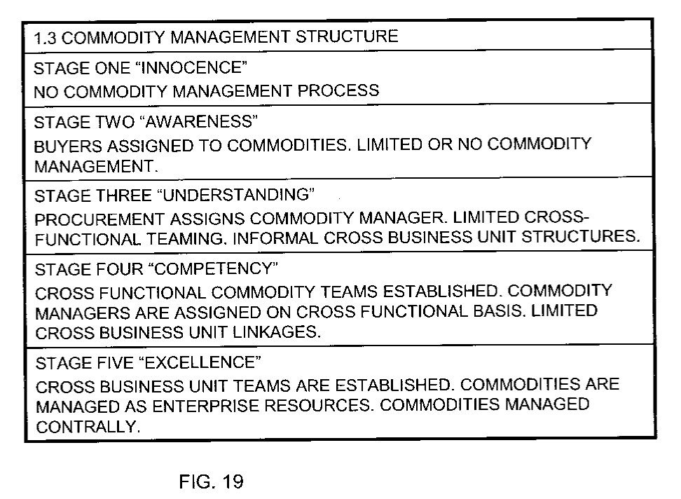

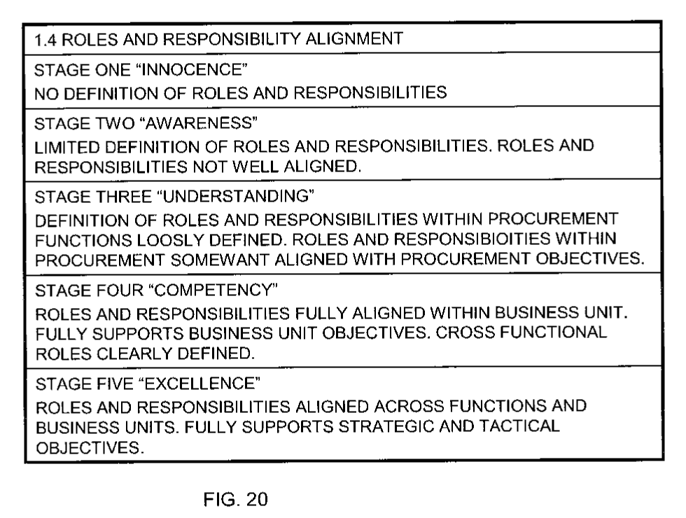

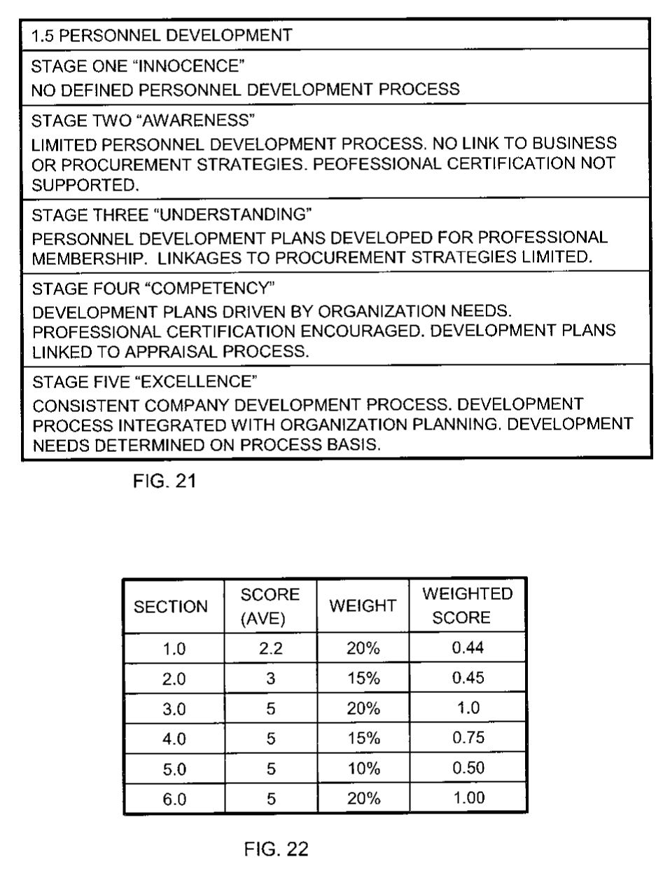

FIG. 6 a presentation 115 of the category specific requirements. Multiple questionnaires such as 112 provide input for category data as in 96. FIG. 7 is a presentation 116 of the maturity assessment frame criteria of 97. The maturity assessment frame includes a series of maturity factors and scoring guidelines 117, which scores are weighted, as will be discussed. As shown in FIG. 8, the scoring values arc “1” for a rating of innocence, “2” for awareness, “3” for understanding, “4” for competency, and “5” for excellence. The definitions for the stages are given in FIG. 16. FIG. 9 includes a listing of the sections 118 of a procurement organization which are scored, and the weighting factor 119 used with each section, which will be explained. Herein, 6 sections are used, and are exemplary only. It will be understood that more or less sections may be used as desired, and may further be used in connection with any organization and its functions which are to be evaluated.

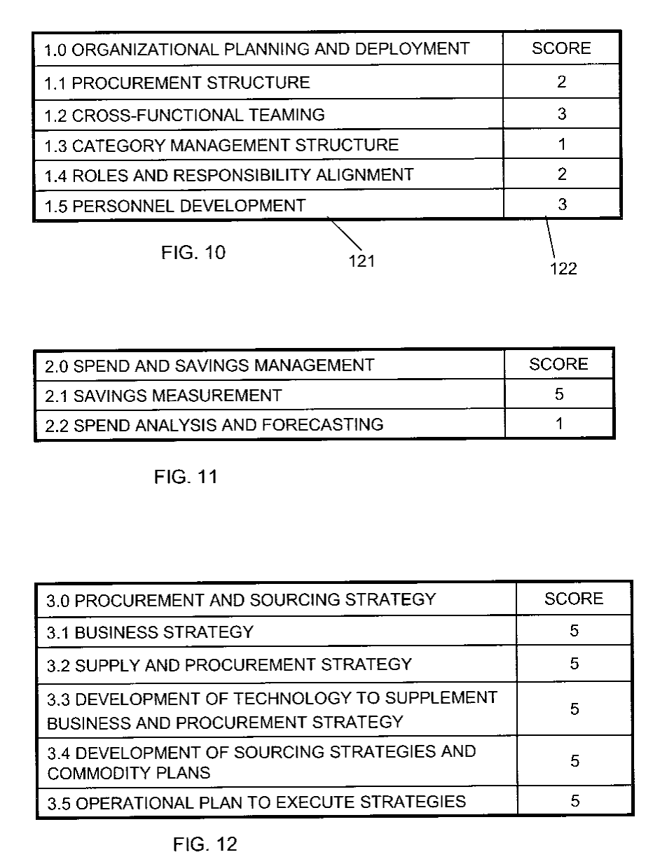

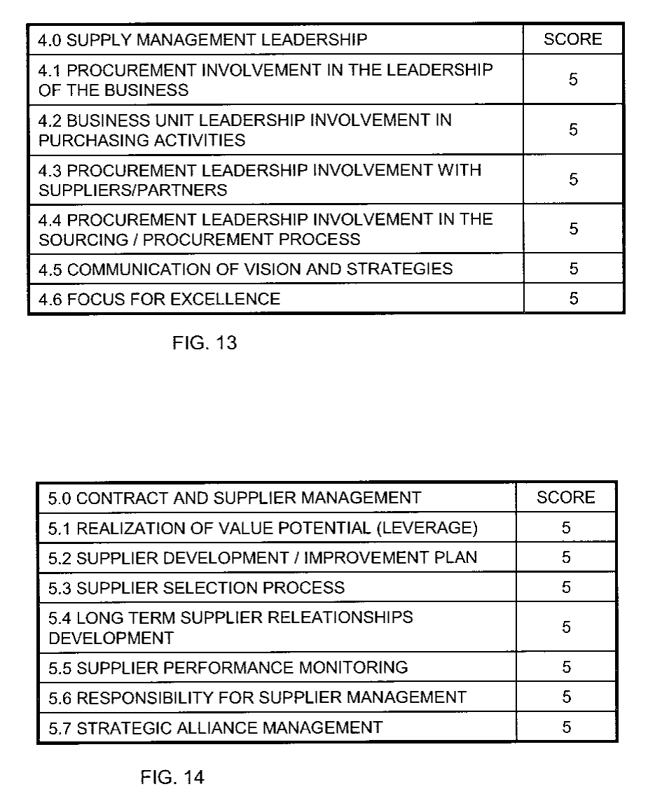

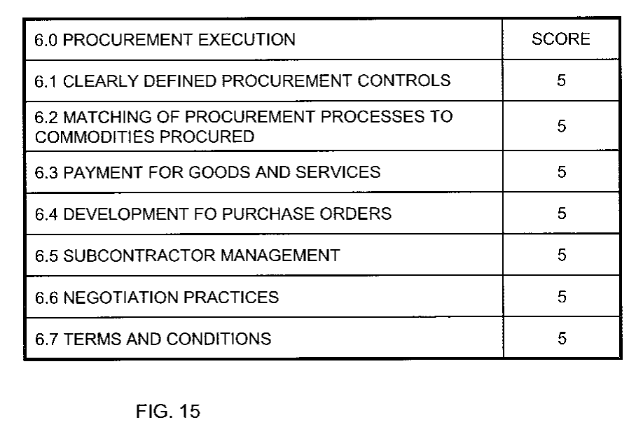

FIGS. 10-15 are illustrations of one embodiment of the sections of FIG. 9. Each section is divided into functions which are separately scored. For instance, 1.0 organizational planning and deployment shown in FIG. 10 is divided into five functions shown at 121, wherein each function is scored in the score column 122. The scores are exemplary only. In one embodiment, FIGS. 10-15 are as shown in the questionnaire. FIG. 16 shows the sourcing maturity indicators 124 with the respective maturity state 125 used to score the functions of the sections, as shown in FIGS. 10-1 5.

Each of the functions of FIGS. 10-15 are evaluated by an evaluator familiar with the function, and guidelines arc established to determine the maturity stages “1” through “5”. Only functions 1.1-1.5 are shown, but is will be understood that similar guidelines are established for all of the functions of the sections 118 of FIG. 9.

As shown in FIG. 22, all of the scores for all of the functions for each section are totaled, and then averaged to give an average score for that section. The average score is then multiplied by the weight to give a weighted score which is used in the savings calculations. For instance, the scores for section 1.0 are 11 (see FIG. 10, 2+3+1+2+3=11). The score is then averaged ( 11/6=2.2). The average score is then multiplied by the weight to give the weighted score (2.2×0.20=0.44). The weighted score is used to identify spend categories that have greater opportunity for achieving savings.

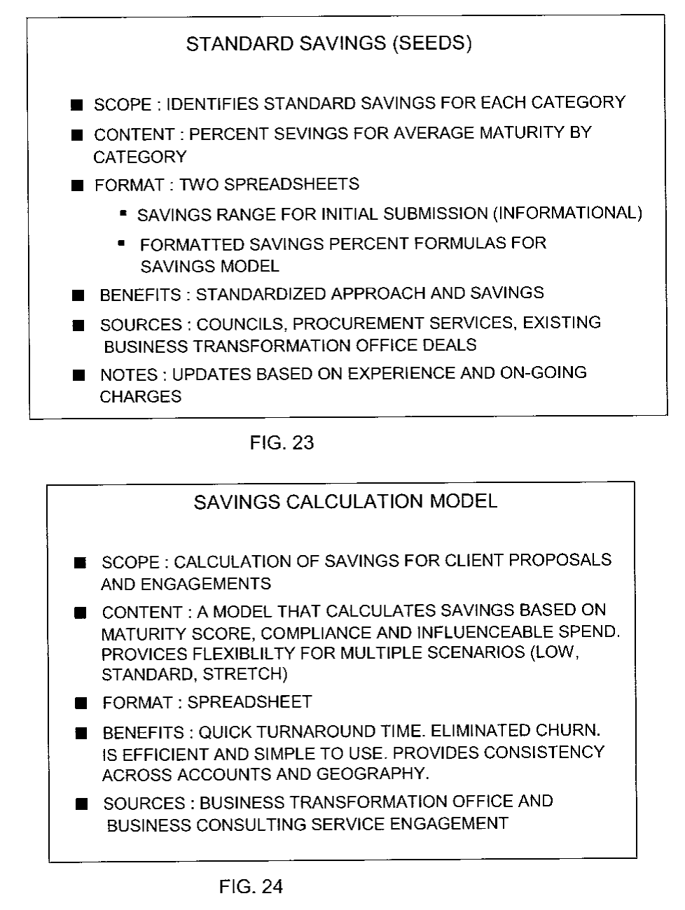

In FIG. 23, the criteria of the standard savings (seeds) of 99 are shown. The format is two spreadsheets for savings range for initial submission and savings percent for the savings model 102. FIG. 24 shows the criteria of the savings calculation model of 100. In one embodiment, the savings calculation model 100 is performed in a spreadsheet which includes an input tab which receives input data from the questionnaires of 95 and 96.

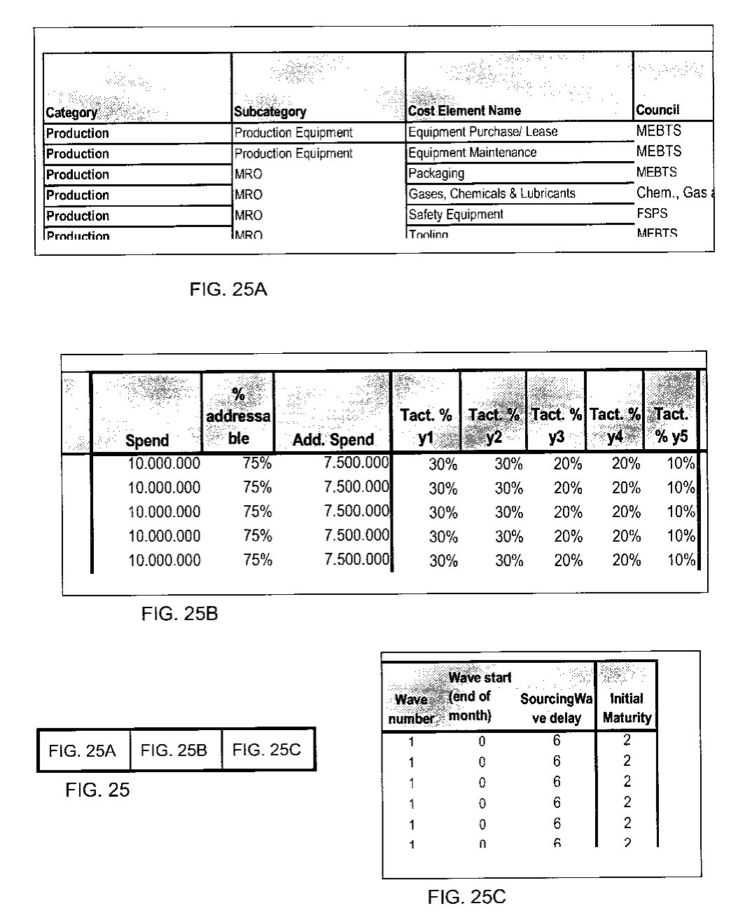

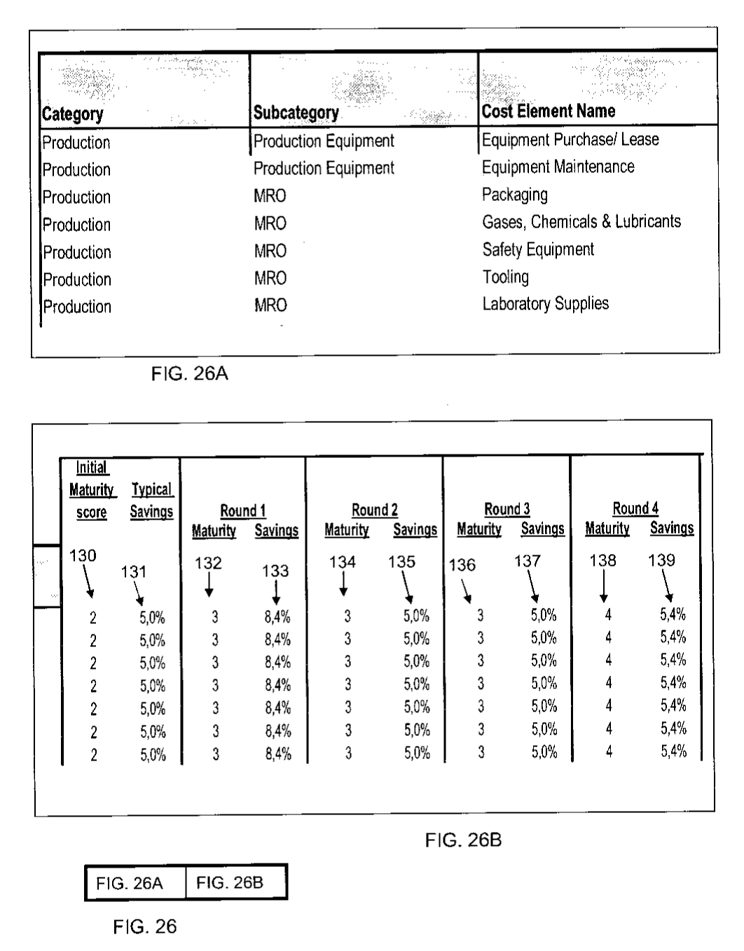

FIGS. 25A, 25B, and 25C, assembled as shown in the map of FIG. 25, is an illustration of partial input tab of the spreadsheet of the savings calculation model 100. FIGS. 26A and 26B assembled as shown in the map of FIG. 26, illustrates an example of a partial scenario maturity profile. This profile is used to study the savings projected to be realized by improving the maturity level from, for instance, 2 to a maturity level of 3 in rounds 1-3, and a maturity level of 4 in round 4. The initial maturity score is shown at 130. The maturity levels of each of the rounds are shown at 132, 134, 136, and 138, respectively. As previously mentioned, savings are estimated as shown at 131 for the typical savings for the initial value, and the savings in percent for each of the rounds as shown at 133, 135, 137, and 139, respectively. These % savings are discussed in connection with seeds in FIG. 23.

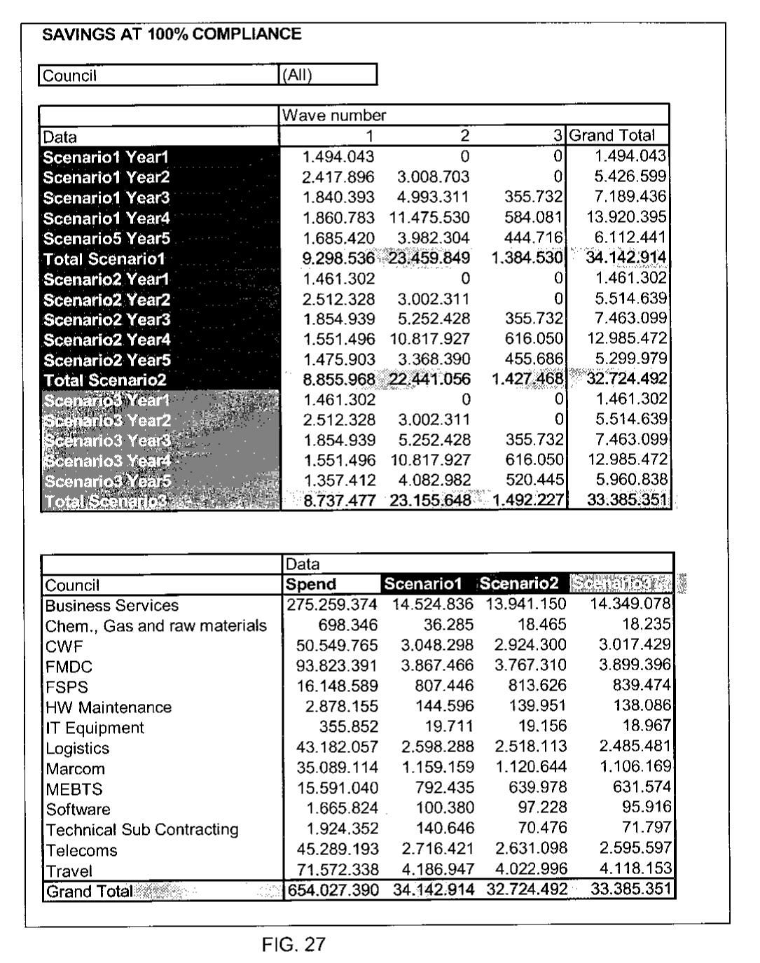

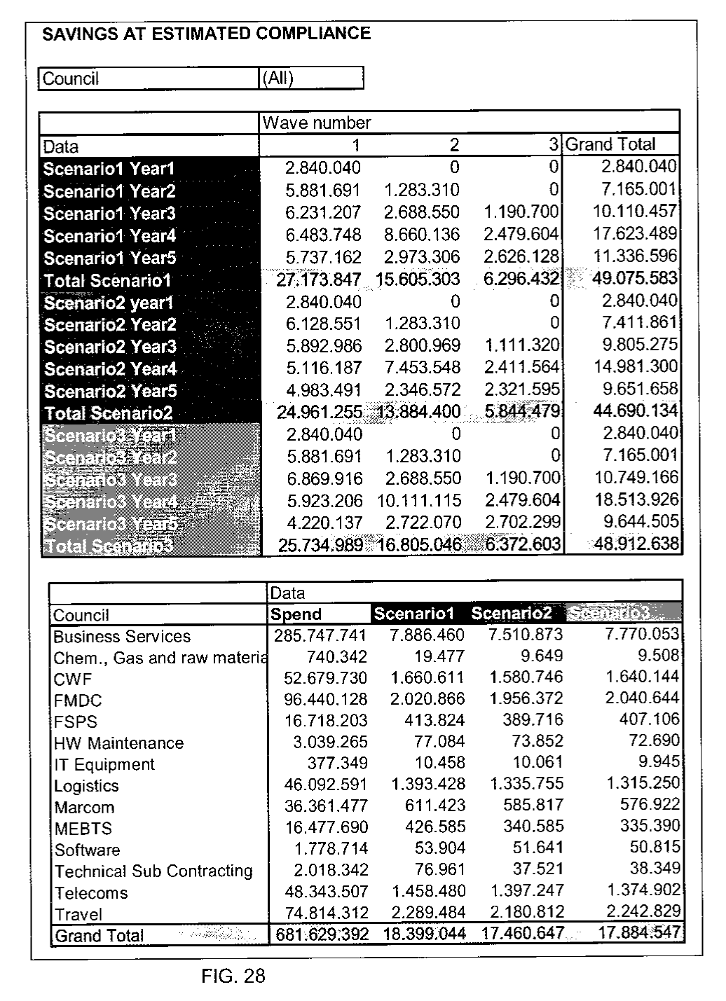

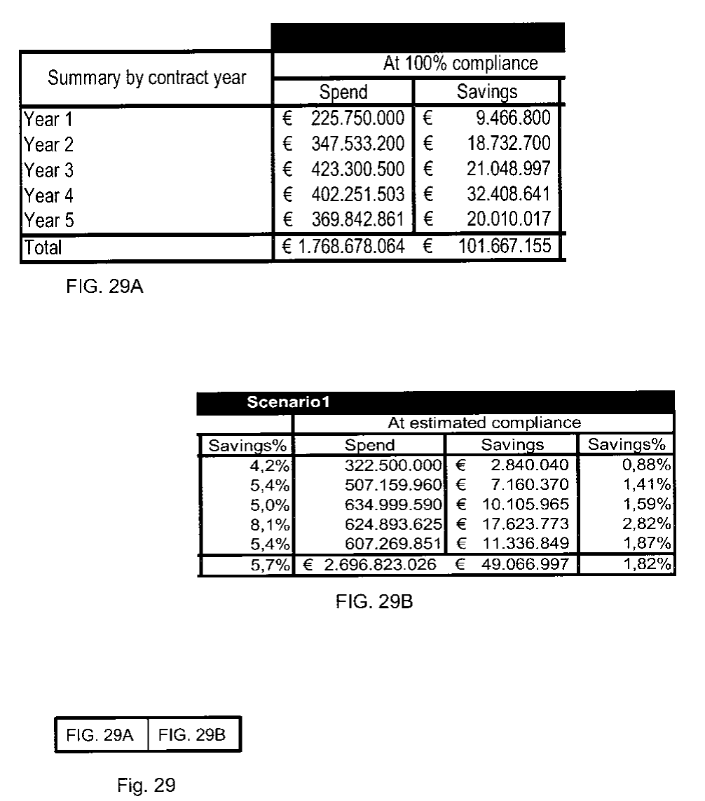

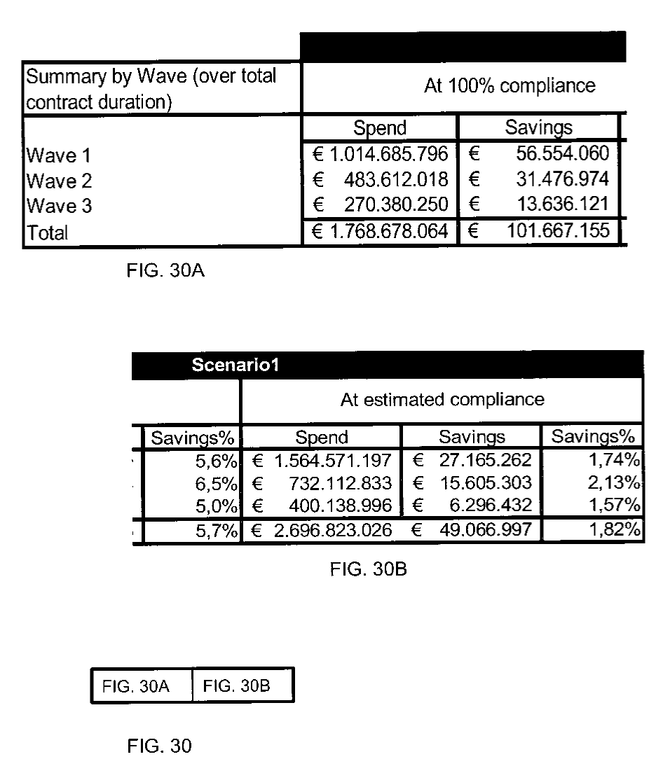

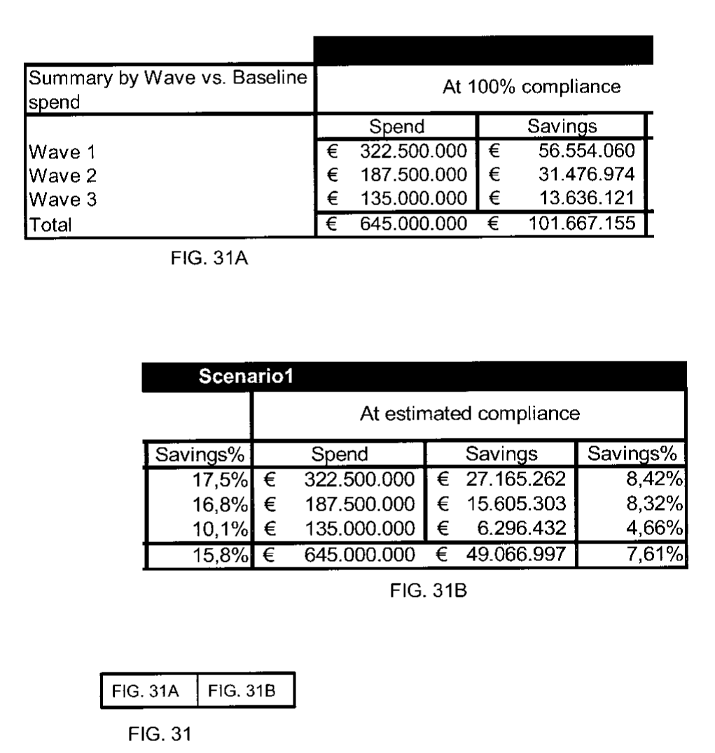

FIG. 27 is an illustration of a partial output tab showing the savings at 100% compliance. FIG. 28 is an illustration of a partial output tab showing the savings at estimated compliance. FIGS. 29A and 29B assembled as shown in the map of FIG. 29 is an illustration of a savings summary of contract year for a scenario. FIGS. 30A and 30B assembled as shown in the map of FIG. 30 is an illustration of a savings summary by wave (over total contract duration). FIGS. 31A and 31B assembled as shown in the map of FIG. 31 is an illustration of a savings summary by wave vs. baseline spend.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method using a computer for estimating savings realized in an enterprise comprising the steps of:
inputting into said computer, data reflecting dividing of the enterprise into sections;
inputting into said computer, data reflecting the dividing of each section into one or more functions and recording the money spent for each function over a specified period of time;
inputting into said computer, data recording the maturity of each function based on standardized criteria and percent improvement data for evaluating savings to be realized as the function improves from one maturity level to a higher maturity level;
said computer estimating savings to be realized for each function as the function matures from one maturity level to a higher maturity level;
said computer consolidating savings to be realized for all functions in a section, and all sections in the enterprise; and
said computer publishing the savings in a report for evaluation.

2. The method of claim 1 wherein said sections include:
1.0 Organization Planning and Deployment,
2.0 Spend and Savings Management,
3.0 Procurement and Sourcing Strategy,
4.0 Supply Management Leadership,
5.0 Contract and Supplier Management, and
6.0 Procurement Execution.

3. The method of claim 1 wherein the maturity levels are:
1. Innocence,
2. Awareness,
3. Understanding,
4. Competency and
5. Excellence.

4. The method of claim 1 wherein data to be input into the computer is entered into an electronic questionnaire, and said method further comprises:
electronically linking said electronic questionnaire to the input tab of a spreadsheet which performs the estimating savings and consolidating savings steps.

5. The method of claim 1 further comprising:
scoring the maturity level of each function;
totaling in each function, the scores of all the functions in that section; and
applying a weight to each section for identifying spend categories that have greater opportunity for achieving savings.

6. A system for calculating client savings comprising:
a spend in scope module for identifying categories for which the client supplies historical spend amounts that the client expended to procure each category for a specified period of time;
a questionnaire module wherein the client provides input data concerning current business processes applied to categories;
a maturity assessment framework module wherein maturity levels are applied to specific categories by standardized criteria;
a resource calculation and savings ranges by category module wherein savings percentage by category for an average maturity level are compiled;
a savings calculation model connected to each of the modules wherein the data gathered by said modules are input into an input tab and savings are calculated based on the maturity of each category improving from an initial value to a higher value, and a client savings model connected to said savings calculation model wherein the savings calculated are published for analysis.

7. The system of claim 6 wherein said questionnaire module includes an electronic questionnaire having questions answered by the client, said electronic questionnaire being electronically linked to said input tab of said savings calculation model.

8. The system of claim 6 wherein said questionnaire module includes a raped scan questionnaire module for providing business process data, and a category specific questionnaire module wherein category specific data is provided.

9. The system of claim 6 wherein said maturity assessment framework module divides the business enterprise of said client into sections, and each section is divided into one or more functions, and each function is assigned a maturity level based on standardized criteria.

10. The system of claim 9 wherein said sections include:
Organizational Planning and Deployment,
Spend and Savings Management,
Procurement and Sourcing Strategy,
Supply Management Leadership.
Contract and Supplier Management, and
Procurement Execution.

11. The system of claim 6 wherein said maturity levels include:
1. Innocence,
2. Awareness,
3. Understanding
4. Competency, and
5. Excellence.

12. The system of claim 6 further comprising:
A savings validation and update module wherein said saving projected are validated by periodic review of actual savings realized and maturity levels are revised.

13. The system of claim 12 wherein said savings validation and update module includes a client feedback/internal adjustment module.

14. The system of claim 9 wherein the maturity level of each function is scored, the scores of all functions in each section is totaled, and a weight is applied to the total score of each section for identifying spend categories that have greater opportunity for achieving savings.

15. A program product for use with a computer for estimating savings realized in an enterprise comprising:
a computer readable medium having recorded thereon computer readable program code for performing the method comprising the steps of:
receiving data recording the dividing of the enterprise into sections for use by said computer;
receiving data recording the dividing each section into one or more functions and recording the money spent for each function over a specified period of time for use by said computer;
receiving maturity data for use by said computer, said maturity data reflecting the maturity of each function based on standardized criteria;
receiving percentage improvement data for use by said computer in evaluating savings to be realized as the function improves from one maturity level to a higher maturity level;
estimating savings to be realized for each function as the function matures from one maturity level to a higher maturity level;
consolidating savings to be realized for all functions in a section, and all sections in the enterprise; and
publishing the savings in a report for evaluation.

16. The program product of claim 15 wherein said sections include:
1.0 Organization Planning and Deployment,
2.0 Spend and Savings Management,
3.0 Procurement and Sourcing Strategy,
4.0 Supply Management Leadership,
5.0 Contract and Supplier Management, and
6.0 Procurement Execution.

17. The program product of claim 15 wherein the maturity levels arc:
1. Innocence,
2. Awareness,
3. Understanding,
4. Competency and
5. Excellence.

18. The program product of claim 15 wherein data to be input into the computer is entered into an electronic questionnaire, and said method further comprises:
electronically linking said electronic questionnaire to the input tab of a spreadsheet which performs the estimating savings and consolidating savings steps.

19. The program product of claim 1 5 wherein the method further comprises:
scoring the maturity level of each function;
totaling in each section, the scores of all of the functions in that section; and
applying a weight to each section for identifying spend categories that have greater opportunity for achieving savings.
